(19) United States
(12) Patent Application Publication
(10) Pub. No.: US 2023/0398613 A1
(43) Pub. Date: Dec. 14, 2023

(54) CUTTING TOOLS AND CUTTING APPARATUS HAVING CONTRARY ROTATING PORTIONS

(71) Applicant: KENNAMETAL INC., Latrobe, PA (US)

(72) Inventors: CHRISTOPH GEY, STETTEN (CH); DOMINIK SCHMID, FURTH (DE); SHUANGYUAN ZHANG, Singapore (SG)

(73) Assignee: KENNAMETAL INC., LATROBE, PA (US)

(21) Appl. No.: 17/840,207

(22) Filed: Jun. 14, 2022

(51) Int. Cl. B23D 45/10; B23D 61/02

(52) U.S. Cl. CPC B23D 45/105; B23D 61/025

(57) ABSTRACT

A cutting tool for cutting a metal workpiece includes a first portion, and a second portion. The first portion includes a first outer surface, a first shaft, and at least one cutting insert attached to the first outer surface. The second portion includes a second outer surface and a second shaft. The first and second shafts are disposed coaxially around an axis. The first and second outer surfaces are disposed adjacent to one another. The first and second outer surfaces are configured to rotate around the axis in opposite directions.

### FIELD OF THE DISCLOSURE

The disclosure relates to metal workpiece cutting tools and cutting apparatus having portions which rotate in opposite directions, and to methods of their use to cut metal workpieces.

### BACKGROUND

When metal workpieces are cut with cutting tools and cutting apparatus, large cutting forces are often created. This increases the bending moment and creates instability in the cutting tool and metal workpiece. This also reduces the speeds and feeds that can be used during the cutting process. As a result, firm clamping of the metal workpiece is required which can be challenging if the metal workpiece has a complex shape, is long and slender, or fragile.

A metal workpiece cutting tool, cutting apparatus, and method of use is needed to reduce one or more issues associated with current metal workpiece cutting tools, cutting apparatus, and methods of cutting metal workpieces.

### SUMMARY

In one embodiment, a cutting tool for cutting a metal workpiece includes a first portion, and a second portion. The first portion includes a first outer surface, a first shaft, and at least one cutting insert attached to the first outer surface. The second portion includes a second outer surface and a second shaft. The first and second shafts are disposed coaxially around an axis. The first and second outer surfaces are disposed adjacent to one another. The first and second outer surfaces are configured to rotate around the axis in opposite directions.

In another embodiment, a cutting apparatus for cutting a metal workpiece includes a first portion, a second portion, a first driving device, and a second driving device. The first portion includes a first outer surface, a first shaft, and at least one cutting insert attached to the first outer surface. The second portion includes a second outer surface and a second shaft. The first and second shafts are disposed coaxially around an axis. The first and second outer surfaces are disposed adjacent to one another. The first driving device is connected to the first shaft. The first driving device is configured to rotate the first outer surface in a first direction around the axis. The second driving device is connected to the second shaft. The second driving device is configured to rotate the second outer surface in a second direction around the axis opposite the first direction.

In still another embodiment, a method of cutting a metal workpiece with a cutting apparatus is disclosed. In one step, a first outer surface of a first cutting portion is rotated with a first driving device in a first direction around an axis to cut the metal workpiece. In another step, a second outer surface of a second portion is simultaneously rotated with a second driving device in a second direction around the axis opposite the first direction to cut the metal workpiece or to provide a counter-rotating mass to reduce a bending moment.

The scope of the present disclosure is defined solely by the appended claims and is not affected by the statements within this summary.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure.

FIG. 1 illustrates a side perspective view of one embodiment of a cutting tool of a cutting apparatus for cutting a metal workpiece;

FIG. 2 illustrates a side view of the cutting tool of the cutting apparatus of the embodiment of FIG. 1;

FIG. 3 illustrates a bottom view of the cutting tool of the cutting apparatus of the embodiment of FIG. 1;

FIG. 4 illustrates a cross-sectional view through line 4-4 of the cutting tool of the cutting apparatus of the embodiment of FIG. 3 with the cutting tool shown cutting a metal workpiece;

FIG. 5 illustrates a disassembled view of the cutting tool of the cutting apparatus of the embodiment of FIG. 1;

FIG. 6 illustrates a side view of the cutting tool of the cutting apparatus of the embodiment of FIG. 1 showing portions of the cutting tool being driven by one embodiment of driving devices;

FIG. 7 illustrates a side view of the cutting tool of the cutting apparatus of the embodiment of FIG. 1 showing portions of the cutting tool being driven by another embodiment of driving devices;

FIG. 8 illustrates a side view of the cutting tool of the cutting apparatus of the embodiment of FIG. 1 showing portions of the cutting tool being driven by yet another embodiment of driving devices;

FIG. 9 illustrates a side view of the cutting tool of the cutting apparatus of the embodiment of FIG. 1 showing portions of the cutting tool being driven by still another embodiment of driving devices;

FIG. 10 illustrates a side view of another embodiment of a cutting tool of a cutting apparatus for cutting a metal workpiece; and

FIG. 11 depicts a flowchart illustrating one embodiment of a method of cutting a metal workpiece with a cutting apparatus.

### DETAILED DESCRIPTION

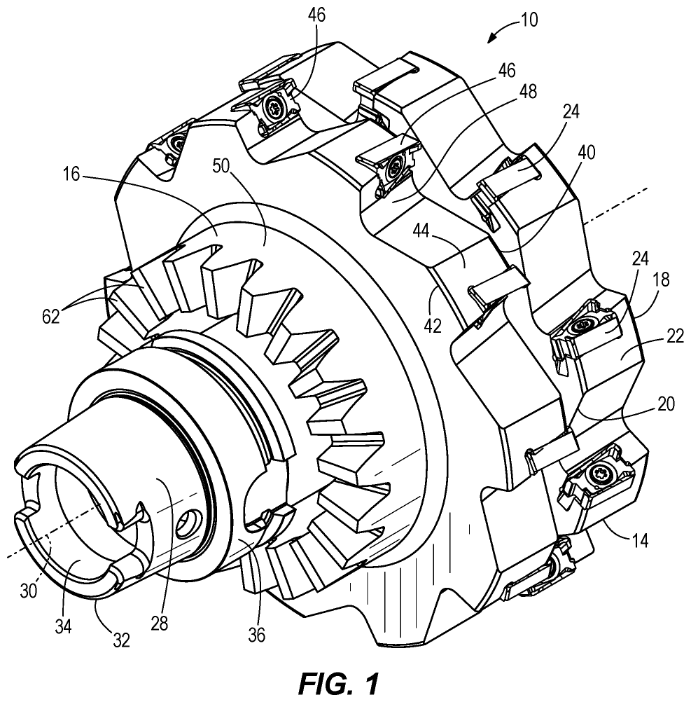

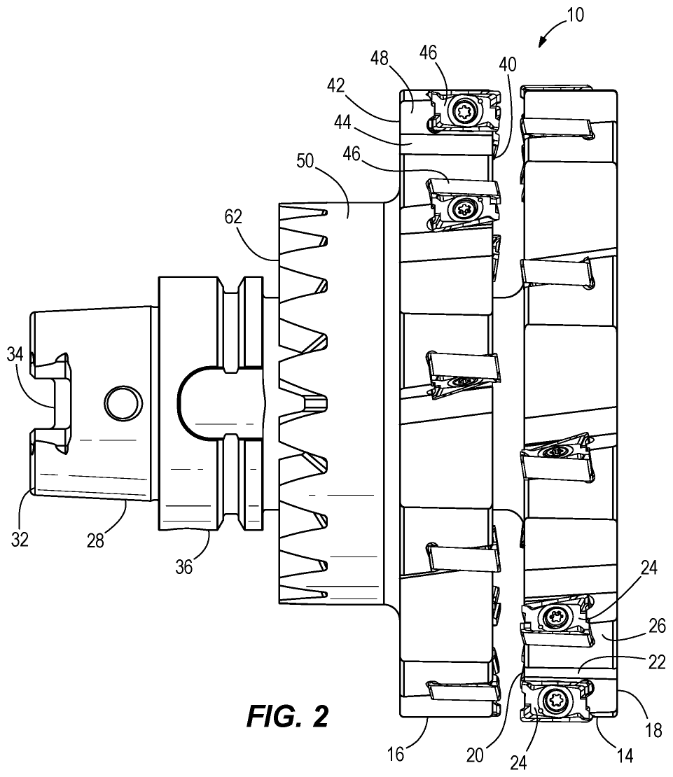

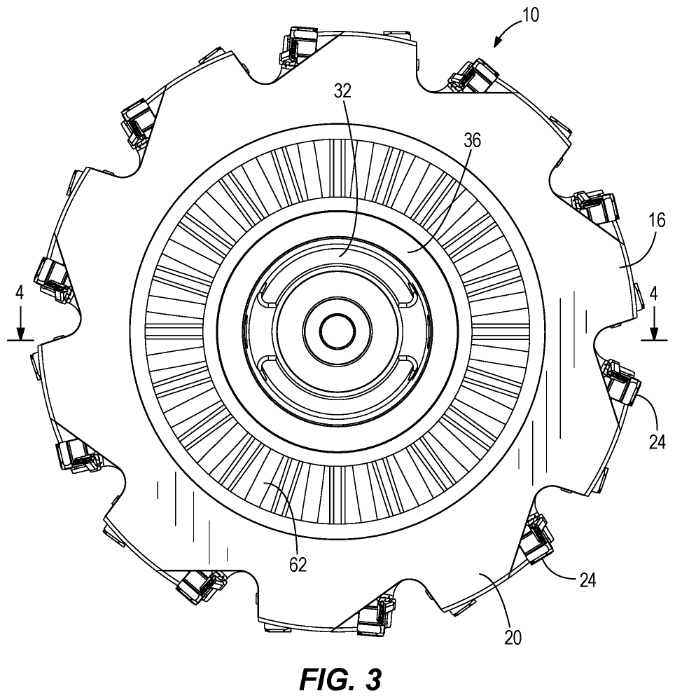

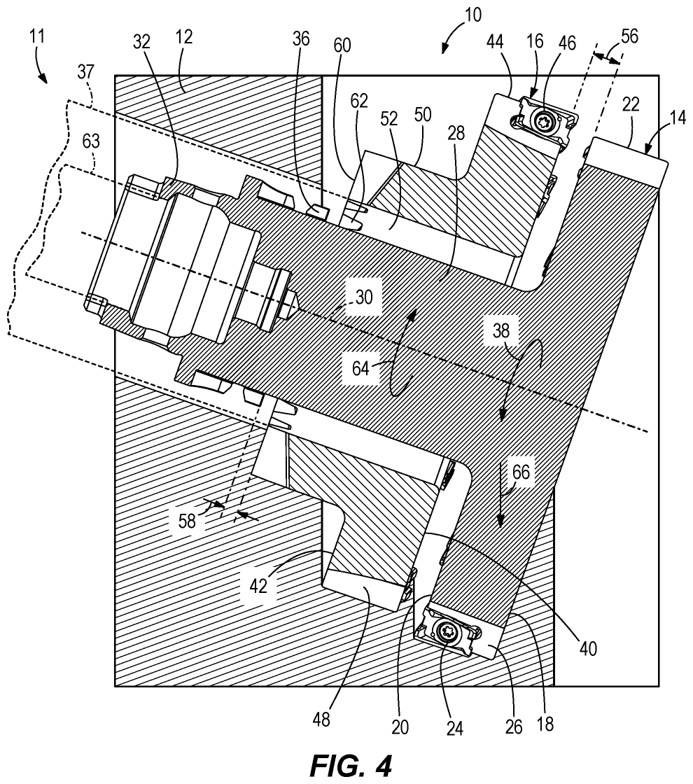

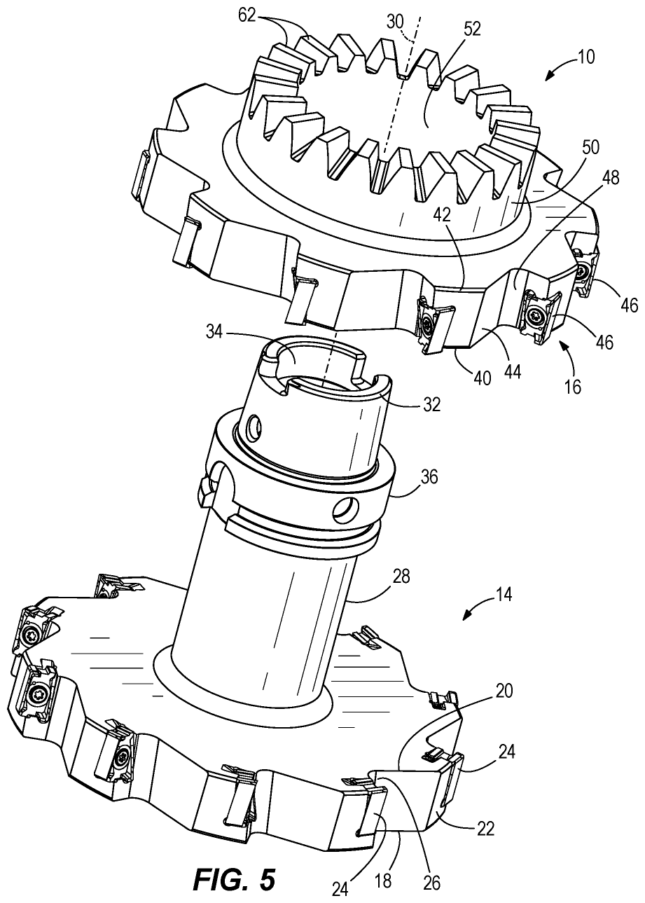

As shown collectively in FIGS. 1-5, in one embodiment a cutting tool 10 of a cutting apparatus 11 for cutting a metal workpiece 12 comprises a first portion 14 and a second portion 16. The first portion 14 comprises opposed surfaces 18 and 20, and an outer surface 22 extending between the opposed surfaces 18 and 20. A plurality of cutting inserts 24 are attached to a plurality of pockets 26 disposed within the outer surface 22. In other embodiments, one or more cutting insert 24 may be attached to one or more pocket 26. A shaft 28 extends perpendicularly from opposed surface 20 around axis 30. One end 32 of the shaft 28 has a hollow interior cavity 34. A shank 36 is attached to and around the shaft 28 near the end 32 of the shaft 28. The first portion 14 is configured to be rotated by driving device 37 around axis 30 in direction 38.

The second portion 16 is rotatably attached to the shaft 28 between the opposed surface 20 and the shank 36 so that the second portion 16 is configured to rotate relative to the first portion 14. The second portion 16 comprises opposed surfaces 40 and 42, and an outer surface 44 extending between the opposed surfaces 40 and 42. A second plurality of cutting inserts 46 are attached to a second plurality of pockets 48 disposed within the outer surface 44. In other embodiments, one or more second cutting insert 46 may be attached to one or more second pocket 48. A shaft 50 of the second portion 16 extends perpendicularly from opposed surface 42 coaxially around axis 30. The shaft 28 extends completely through an inner cavity 52 in the second portion 16. The inner cavity 52 extends from opposed surface 40, through opposed surface 42, through the shaft 50. Outer surface 22 of the first portion 14 is disposed adjacent to outer surface 44 of the second portion 16. Gap 56 is disposed between opposed surface 20 of the first portion 14 and opposed surface 40 of the second portion 16, and between outer surface 22 of the first portion 14 and outer surface 44 of the second portion 16. Gap 58 is disposed between an end 60 of the shaft 50 of the second portion 16 and shank 36. The end 60 of the shaft 50 comprises teeth 62.

The second portion 16 is configured to be rotated by driving device 63 relative to the first portion 14 around axis 30 in direction 64 which is opposite to direction 38. Driving devices 37 and 63 can comprise any type and number of driving devices such as one or more portions of one or more motors, one or more gearboxes, or one or more additional types of driving devices. In other embodiments, the first portion 14 may be configured to be rotated by the driving device 37 around axis 30 in direction 64 and the second portion 16 may be configured to be rotated by the driving device 63 relative to the first portion 14 around axis 30 in direction 38. The cutting tool 10 is configured to move relative to the metal workpiece 12 along a feed axis 66. The feed axis 66 is disposed non-parallel and non-perpendicular to the axis 30. In other embodiments, one or more components of the cutting tool 10 of FIGS. 1-5 may not be present, may be varied in number, type, configuration, location, and/or in other ways, and/or one or more additional components may be present.

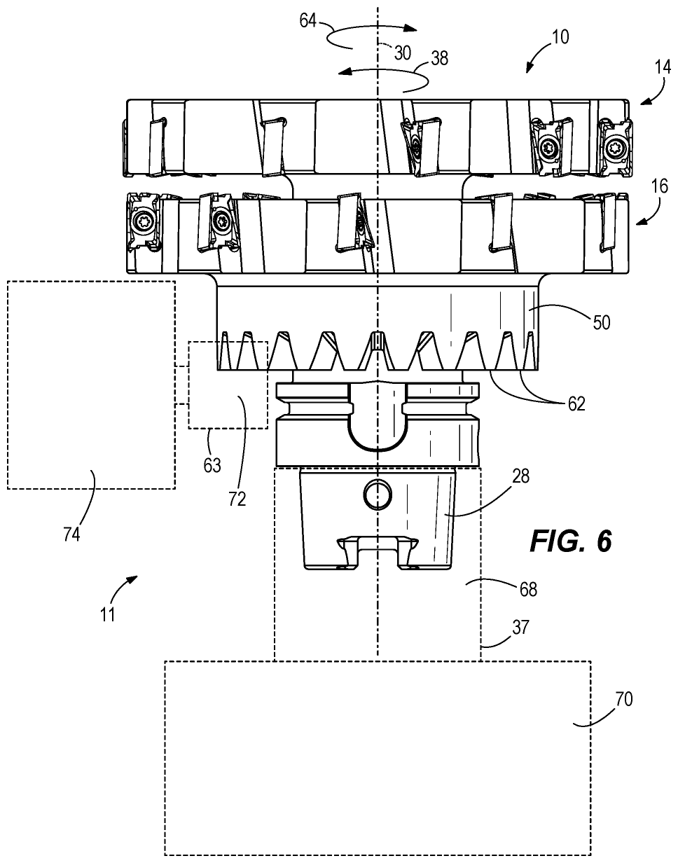

As shown in FIG. 6, in another embodiment the first portion 14 of the cutting tool 10 of the cutting apparatus 11 of FIGS. 1-5 may be rotated in direction 38 around axis 30 by a driving device 37 comprising a spindle 68 of a motor 70, and the second portion 16 of the cutting tool 10 of FIGS. 1-5 may be driven in direction 64 around axis 30 by a driving device 63 comprising a spindle 72 of motor 74. The spindle 68 of the motor 70 of driving device 37 is connected to the shaft 28 of the first portion 14. The spindle 72 of the motor 74 of driving device 63 is connected to the teeth 62 of the shaft 50 of the second portion 16. Spindles 68 and 72 are oriented perpendicularly to one another.

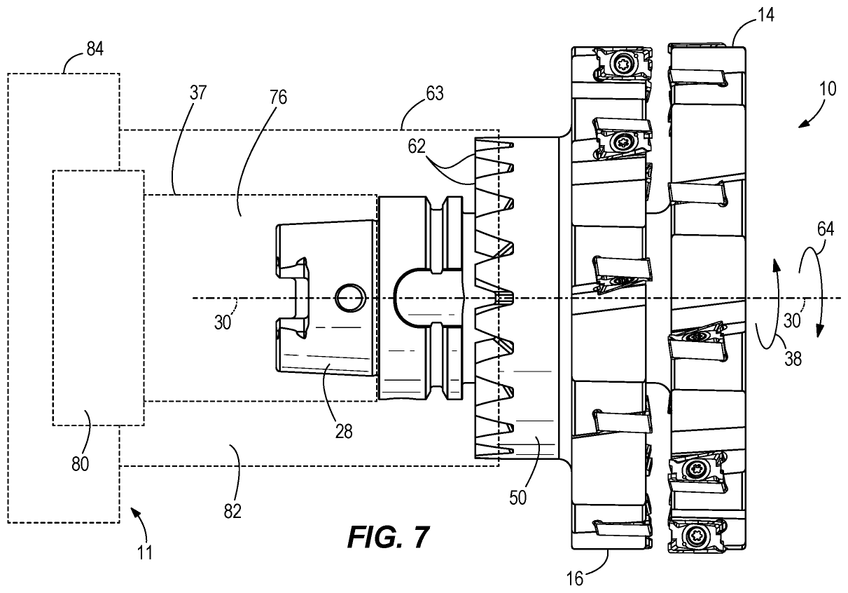

As shown in FIG. 7, in still another embodiment the first portion 14 of the cutting tool 10 of the cutting apparatus 11 of FIGS. 1-5 may be rotated in direction 38 around axis 30 by a driving device 37 comprising a spindle 76 of a motor 80, and the second portion 16 of the cutting tool 10 of FIGS. 1-5 may be driven in direction 64 around axis 30 by a driving device 63 comprising a spindle 82 of motor 84. The spindle 76 of the motor 80 of driving device 37 is connected to the shaft 28 of the first portion 14. The spindle 82 of the motor 84 of driving device 63 is connected to the teeth 62 of the shaft 50 of the second portion 16. Spindles 76 and 82 are oriented co-axial and parallel to one another.

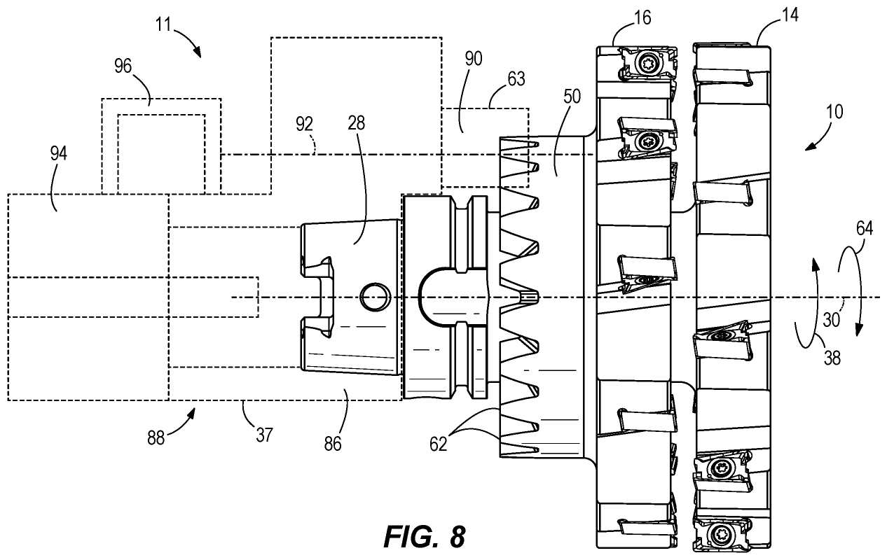

As shown in FIG. 8, in still another embodiment the first portion 14 of the cutting tool 10 of the cutting apparatus 11 of FIGS. 1-5 may be rotated in direction 38 around axis 30 by a driving device 37 comprising a first portion 86 of a gearbox 88, and the second portion 16 of the cutting tool 10 of FIGS. 1-5 may be driven in direction 64 around axis 30 by a driving device 63 comprising a second portion 90 of the gearbox 88. The first portion 86 of the gearbox 88 is connected to shaft 28 of the first portion 14. The second portion 90 of the gearbox 88 is connected to the teeth 62 of the shaft 50 of the second portion 16. First portion 86 of the gearbox 88 rotates around axis 30, while second portion 90 of the gearbox 88 rotates around parallel axis 92. The gearbox 88 is powered by motor 94 which drives portions 86 and 90 of the gearbox 88 to produce outputs of the portions 86 and 90 in different directions. A stabilizing member 96 is connected to and between the gearbox 88 and the motor 94. The stabilizing member 96 prevents a spinning movement of the gearbox 88 in one or more directions.

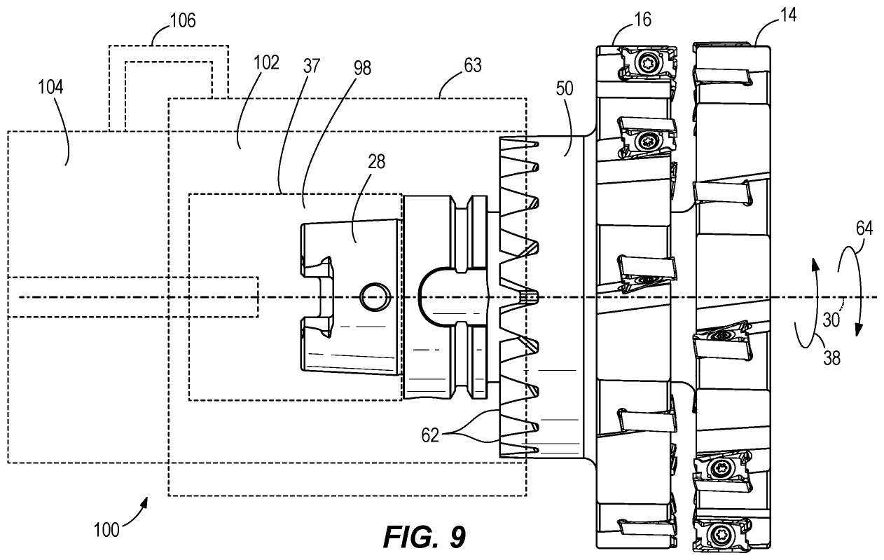

As shown in FIG. 9, in yet another embodiment the first portion 14 of the cutting tool 10 of the cutting apparatus 11 of FIGS. 1-5 may be rotated in direction 38 around axis 30 by a driving device 37 comprising a first portion 98 of a gearbox 100, and the second portion 16 of the cutting tool 10 of FIGS. 1-5 may be driven in direction 64 around axis 30 by a driving device 63 comprising a second portion 102 of the gearbox 100. The first portion 98 of the gearbox 100 is connected to shaft 28 of the first portion 14. The second portion 102 of the gearbox 100 is connected to the teeth 62 of the shaft 50 of the second portion 16. First and second portions 98 and 102 of the gearbox 100 co-axially rotate around axis 30. The gearbox 100 is powered by motor 104 which drives first and second portions 98 and 102 of the gearbox 100 to produce outputs of the first and second portions 98 and 102 in different directions. A stabilizing member 106 is connected to and between the gearbox 100 and the motor 104. The stabilizing member 106 prevents a spinning movement of the gearbox 100 in one or more directions.

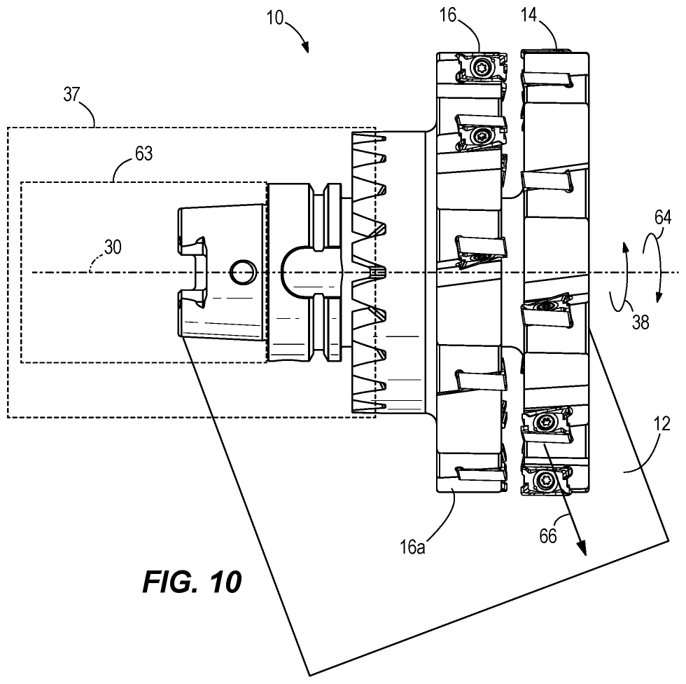

As shown in FIG. 10, in an additional embodiment the cutting tool 10 of the cutting apparatus 11 of FIGS. 1-5 may be identical in all respects except the second portion 16 may comprise a counter-rotating mass 16a, of equal or lesser size than first portion 14, which does not comprise any cutting inserts. As such, the second portion 16 of FIG. 10, unlike the first portion 14, may not be used to cut a metal workpiece 12. The first portion 14 is configured to be rotated by driving device 37 around axis 30 in direction 38. The second portion 16 is configured to be rotated by driving device 63 relative to the first portion 14 around axis 30 in direction 64 which is opposite to direction 38. Driving devices 37 and 63 can comprise any type and number of driving devices such as one or more portions of one or more motors, one or more gearboxes, or one or more additional types of driving devices. In other embodiments, the first portion 14 may be configured to be rotated by the driving device 37 around axis 30 in direction 64 and the second portion 16 may be configured to be rotated by the driving device 63 relative to the first portion 14 around axis 30 in direction 38. The cutting tool 10 is configured to move relative to the metal workpiece 12 along a feed axis 66. The feed axis 66 is disposed non-parallel and non-perpendicular to the axis 30.

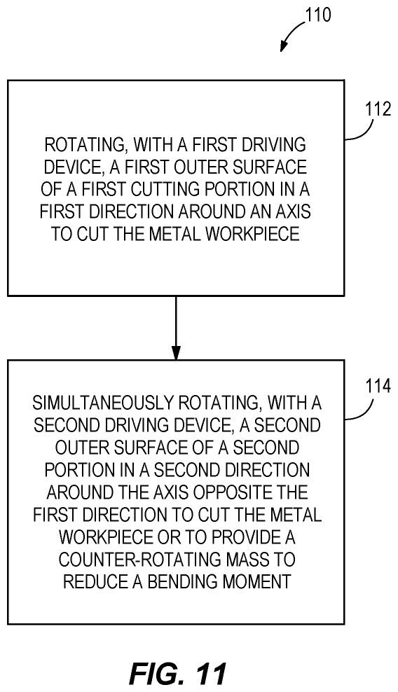

FIG. 11 illustrates one embodiment of a method 110 of cutting a metal workpiece with a cutting apparatus. The method 110 may utilize any of the cutting tools and cutting apparatus disclosed herein. In other embodiments, the method 110 may utilize varying cutting tools and/or cutting apparatus.

Step 112 comprises rotating, with a first driving device, a first outer surface of a first cutting portion in a first direction around an axis to cut the metal workpiece. Step 114 comprises simultaneously rotating, with a second driving device, a second outer surface of a second portion in a second direction around the axis opposite the first direction to cut the metal workpiece or to provide a counter-rotating mass to reduce a bending moment.

In one embodiment, the simultaneously rotating comprises simultaneously rotating the second outer surface of the second portion in the second direction around the axis opposite the first direction to cut the metal workpiece. In another embodiment, the simultaneously rotating comprises simultaneously rotating the second outer surface of the second portion in the second direction around the axis opposite the first direction to provide the counter-rotating mass to reduce the bending moment.

In one embodiment, the method 110 further comprises simultaneously feeding the metal workpiece relative to a tool along a feed axis. The tool comprises the first cutting portion and the second portion, and the feed axis is disposed non-perpendicular and non-parallel to the axis.

In another embodiment, the first driving device comprises a first motor and the second driving device comprises a second motor.

In yet another embodiment, the first and second driving devices comprise different portions of a gearbox powered by a motor.

In other embodiments, one or more steps of the method 110 may be varied in substance or order, one or more additional steps may be added, and/or one or more steps of the method 110 may not be followed.

The cutting tools, cutting apparatus, and methods of cutting disclosed in the instant disclosure result in reduced cutting forces being placed on metal workpieces during cutting. This is due to the contrary rotating direction cutting portions, and or opposed direction counter-rotating mass, canceling out force components in the opposite direction. As a result, the resulting surface pattern on the metal workpiece is improved. Moreover, this results in less clamping force being required to be placed on the metal workpiece. This reduces bending moments on the cutting tool and metal workpiece. The gained stability can be used to increase the speeds and feeds associated with cutting the metal workpiece. The resulting crisscross pattern on the surface of the metal workpiece is beneficial for many applications especially those that involve friction.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true scope of the subject matter described herein. Furthermore, it is to be understood that the disclosure is defined by the appended claims. Accordingly, the disclosure is not to be restricted except in light of the appended claims and their equivalents.

1. A cutting tool for cutting a metal workpiece comprising:
a first portion comprising a first outer surface, a first shaft, and at least one cutting insert attached to the first outer surface; and
a second portion comprising a second outer surface, and a second shaft;
wherein the first and second shafts are disposed coaxially around an axis, the first and second outer surfaces are disposed adjacent to one another, and the first and second outer surfaces are configured to rotate around the axis in opposite directions.

2. The cutting tool of claim 1 wherein the second portion comprises at least one second cutting insert attached to the second outer surface.

3. The cutting tool of claim 1 wherein the second portion comprises a counter-rotating mass which does not comprise a cutting member.

4. The cutting tool of claim 1 wherein a gap is disposed between the first and second outer surfaces.

5. The cutting tool of claim 1 further comprising a gearbox connected to the first or second portions.

6. A cutting apparatus for cutting a metal workpiece comprising:
a first portion comprising a first outer surface, a first shaft, and at least one cutting insert attached to the first outer surface;
a second portion comprising a second outer surface and a second shaft, wherein the first and second shafts are disposed coaxially around an axis, the first and second outer surfaces being disposed adjacent to one another;
a first driving device connected to the first shaft, the first driving device configured to rotate the first outer surface in a first direction around the axis; and
a second driving device connected to the second shaft, the second driving device configured to rotate the second outer surface in a second direction around the axis opposite the first direction.

7. The cutting apparatus of claim 6 wherein the second portion comprises at least one second cutting insert attached to the second outer surface.

8. The cutting apparatus of claim 6 wherein the second portion comprises a counter-rotating mass which does not comprise a cutting member.

9. The cutting apparatus of claim 6 wherein a gap is disposed between the first outer surface and the second outer surface.

10. The cutting apparatus of claim 6 wherein the first driving device comprises a first motor and the second driving device comprises a second motor.

11. The cutting apparatus of claim 6 wherein the first and second driving devices comprise different portions of a gearbox.

12. The cutting apparatus of claim 11 further comprising a motor, wherein the gearbox is driven by the motor.

13. The cutting apparatus of claim 12 further comprising a stabilizing member, wherein the stabilizing member is connected to and between the gearbox and the motor, the stabilizing member preventing a spinning movement of the gearbox in at least one direction.

14. The cutting apparatus of claim 6 further comprising a tool comprising the first portion and the second portion, the tool configured to move relative to the metal workpiece along a feed axis, the axis disposed non-parallel and non-perpendicular to the feed axis.

15. A method of cutting a metal workpiece with a cutting apparatus comprising:
rotating, with a first driving device, a first outer surface of a first cutting portion in a first direction around an axis to cut the metal workpiece; and
simultaneously rotating, with a second driving device, a second outer surface of a second portion in a second direction around the axis opposite the first direction to cut the metal workpiece or to provide a counter-rotating mass to reduce a bending moment.

16. The method of claim 15 wherein the simultaneously rotating comprises simultaneously rotating the second outer surface of the second portion in the second direction around the axis opposite the first direction to cut the metal workpiece.

17. The method of claim 15 wherein the simultaneously rotating comprises simultaneously rotating the second outer surface of the second portion in the second direction around the axis opposite the first direction to provide the counter-rotating mass to reduce the bending moment.

18. The method of claim 15 further comprising simultaneously feeding the metal workpiece relative to a tool along a feed axis, the tool comprising the first cutting portion and the second portion, the feed axis being disposed non-perpendicular and non-parallel to the axis.

19. The method of claim 15 wherein the first driving device comprises a first motor and the second driving device comprises a second motor.

20. The method of claim 15 wherein the first and second driving devices comprise different portions of a gearbox powered by a motor.
